(19) United States
(12) Patent Application Publication
(10) Pub. No.: US 2024/0145829 A1
(43) Pub. Date: May 2, 2024

(54) SECONDARY BATTERY

(71) Applicant: Samsung SDI Co., Ltd., Yongin-si (KR)

(72) Inventor: Hyun Soo LEE, Yongin-si (KR)

(21) Appl. No.: 18/358,509

(22) Filed: Jul. 25, 2023

(30) Foreign Application Priority Data
Oct. 28, 2022 (KR) 10-2022-0141350

(51) Int. Cl. H01M 50/171; H01M 50/103; H01M 50/30; H01M 50/553

(52) U.S. Cl. CPC H01M 50/171; H01M 50/103; H01M 50/30; H01M 50/553

(57) ABSTRACT

A secondary battery includes an electrode assembly having a first electrode tab exposed at a first side and a second electrode tab exposed at a second side, a case accommodating the electrode assembly and having a first side opening and a second side opening, a first cap plate sealing the first side opening of the case, a first terminal electrically connected to the first electrode tab and exposed to the outside of the first cap plate, a second cap plate sealing the second side opening of the case, and a second terminal electrically connected to the second electrode tab and exposed to the outside of the second cap plate. The case includes two safety vents on one surface of the case such that internal gas and heat are easily discharged, and thus can prevent heat propagation to adjacent secondary batteries when an event occurs.

### CROSS-REFERENCE TO RELATED APPLICATION

This application claims priority to and the benefit of Korean Patent Application No. 10-2022-0141350, filed on Oct. 28, 2022, in the Korean Intellectual Property Office, the disclosure of which is incorporated by reference herein in its entirety.

### BACKGROUND

### 1. Field

Various embodiments of the present disclosure relate to a secondary battery.

### 2. Description of the Related Art

A secondary battery is a power storage system that provides excellent energy density capable of converting electrical energy into chemical energy and storing the same. Compared to non-rechargeable primary batteries, secondary batteries are rechargeable and are widely used in IT devices such as smart phones, cellular phones, notebooks, and tablet PCs. Recently, interest in electric vehicles has increased to prevent environmental pollution, and accordingly, high-capacity secondary batteries are being adopted for electric vehicles. These secondary batteries are required to have characteristics such as high density, high power, and stability.

The above information disclosed in this Background section is only for enhancement of understanding of the background of the disclosure and therefore it may contain information that does not constitute prior art.

### SUMMARY

The present disclosure provides a secondary battery capable of improving safety, wherein, by having two vents spaced apart from each other in the longitudinal direction of the case, internal gas and heat are easily discharged, and thus can prevent heat propagation to adjacent secondary batteries when an event occurs.

A secondary battery according to an embodiment of the present disclosure, may include an electrode assembly having a first electrode tab exposed at a first side and a second electrode tab exposed at a second side, a case accommodating the electrode assembly and having a first open end corresponding to the first side of the electrode assembly and a second open end corresponding to the second side of the electrode assembly, a first cap plate sealing the first open end of the case, a first terminal electrically connected to the first electrode tab and exposed to the outside of the first cap plate, a second cap plate sealing the second open end of the case, and a second terminal electrically connected to the second electrode tab and exposed to the outside of the second cap plate, and wherein the case includes two or more safety vents on one surface of the case.

The case may include a rectangular lower surface extending in a longitudinal direction; a rectangular upper surface extending along the longitudinal direction and facing the rectangular lower surface; and two long side surfaces connecting long sides of the rectangular lower surface and the rectangular upper surface.

The case may have a rectangular parallelepiped shape, and the case may include an upper surface, a lower surface, and the two long side surfaces that are integral.

The safety vent may include a first safety vent and a second safety vent spaced apart from each other along the longitudinal direction of the case.

Each of the first safety vent and the second safety vent may have a notch having a smaller thickness than other regions of the safety vents.

The shape and thickness of the notch of the first safety vent may be the same as those of the notch of the second safety vent.

The notch may include a central slit extending in a longitudinal direction and additional slits extending outward at a predetermined angle from both ends of the central slit.

The additional slits may include two additional slits extending obliquely from one end of the central slit and two additional slits extending obliquely from the other end of the central slit.

The first safety vent and the second safety vent may have an elongated circular shape extending in the longitudinal direction of the case.

The first safety vent and the second safety vent may have widths greater than a width of the case in a region including the first safety vent and the second safety vent.

The first terminal may include a first inner terminal plate inside the first cap plate, a first outer terminal plate outside the first cap plate, and a first terminal pillar coupled to the first inner terminal plate from the inside of the first cap plate and penetrating the first cap plate to be coupled to the first outer terminal plate from the outside of the first cap plate.

The secondary battery may further include a second cap plate sealing the second open end of the case and a second terminal electrically connected to the second electrode tab and exposed to the outside of the second cap plate.

The secondary battery may further include a first current collector electrically connecting the first electrode tab and the first terminal, and a second current collector electrically connecting the second electrode tab and the second terminal.

A length of the case in the longitudinal direction may be twice or more than a length of the case in the height direction.

The case may have a longitudinal length of 300 mm or more.

The safety vents may be formed on a lower surface of the case.

### BRIEF DESCRIPTION OF DRAWINGS

FIG. 1 is a perspective view of a secondary battery according to an embodiment of the present disclosure.

FIG. 2 is a cross-sectional view of the secondary battery of FIG. 1 taken along line 2-2′.

FIG. 3 is a plan view of a secondary battery of FIG. 1.

FIG. 4 shows experimental results based on the number of vents and the internal pressure per area of the secondary battery shown in FIGS. 1 to 3.

### DETAILED DESCRIPTION

Hereinafter, preferred embodiments of the present disclosure will be described in detail with reference to the accompanying drawings.

Embodiments of the present disclosure are provided to more fully describe the present disclosure to those skilled in the art, and the following embodiments may be embodied in many different forms and should not be construed as being limited to the example embodiments set forth herein. Rather, these example embodiments are provided so that this disclosure will be thorough and complete and will convey the aspects and features of the present disclosure to those skilled in the art.

In addition, in the accompanying drawings, sizes or thicknesses of various components are exaggerated for brevity and clarity. Like numbers refer to like elements throughout. In addition, it will be understood that when an element A is referred to as being “connected to” an element B, the element A can be directly connected to the element B or an intervening element C may be present therebetween such that the element A and the element B are indirectly connected to each other. As used herein, the term “and/or” includes any and all combinations of one or more of the associated listed items.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms that the terms “comprise” and/or “comprising,” when used in this specification, specify the presence of stated features, numbers, steps, operations, elements, and/or components, but do not preclude the presence or addition of one or more other features, numbers, steps, operations, elements, components, and/or groups thereof.

It will be understood that, although the terms first, second, etc. may be used herein to describe various members, elements, regions, layers and/or sections, these members, elements, regions, layers and/or sections should not be limited by these terms. These terms are only used to distinguish one member, element, region, layer and/or section from another. Thus, for example, a first member, a first element, a first region, a first layer and/or a first section discussed below could be termed a second member, a second element, a second region, a second layer and/or a second section without departing from the teachings of the present disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the element or feature in the figures is turned over, elements described as “below” or “beneath” other elements or features would then be oriented “on” or “above” the other elements or features. Thus, the exemplary term “below” can encompass both an orientation of above and below.

A preferred embodiment of the present disclosure will be described in detail with reference to the accompanying drawings to the extent that those skilled in the art can easily practice the present disclosure.

Here, the same reference numerals are assigned to parts having similar configurations and operations throughout the specification. In addition, when a part is said to be electrically coupled to another part, this includes not only a case where it is directly connected but also a case where it is connected with another element interposed therebetween.

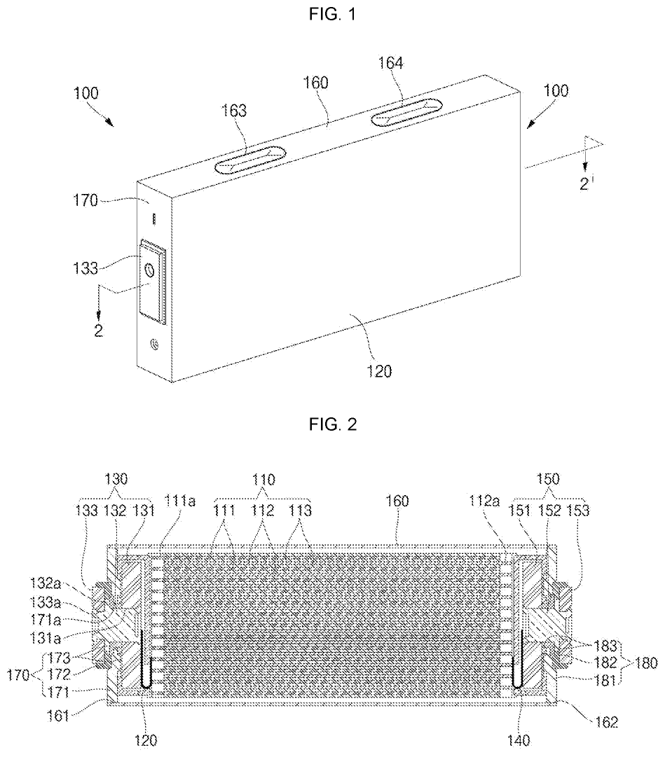

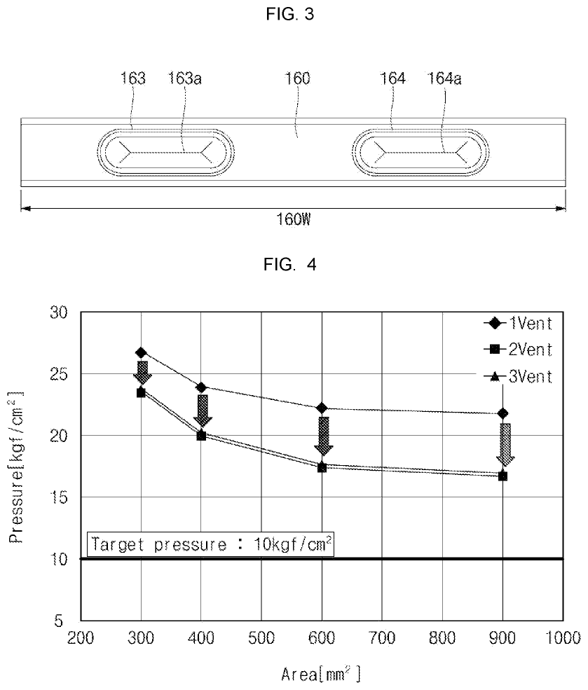

Referring to FIG. 1, a perspective view of a secondary battery 100 according to an embodiment of the present disclosure is shown. Referring to FIG. 2, a cross-sectional view of the secondary battery of FIG. 1 taken along line 2-2′ is shown. Referring to FIG. 3, a plan view of the secondary battery of FIG. 1 is shown.

As shown in FIGS. 1 to 3, the secondary battery 100 may include an electrode assembly 110, a first current collector 120, a first terminal 130, a second current collector 140, a second terminal 150, a case 160, a first cap assembly 170, and a second cap assembly 180.

The electrode assembly 110 may be formed by winding or stacking a stack of a first electrode plate 111, a separator 113, and a second electrode plate 112, which are formed in a thin plate shape or film shape. When the electrode assembly 110 is a wound stack, a winding axis may be parallel to the longitudinal direction of the case 160. Hereinafter, the longitudinal direction refers to the longitudinal direction of the case 160.

In addition, the electrode assembly 110 may be a stack type rather than a winding type, and the shape of the electrode assembly 110 is not limited in the present disclosure. In addition, one or more electrode assemblies 110 may be stacked such that long sides of the electrode assemblies 110 are adjacent to each other and accommodated in the case 160. In the present disclosure, the number of electrode assemblies 110 is not limited.

The first electrode plate 111 of the electrode assembly 110 may serve as a negative electrode, and the second electrode plate 112 may serve as a positive electrode. In one or more embodiments, the first electrode plate may serve as the positive electrode and the second electrode plate 112 may serve as the negative electrode.

The first electrode plate 111 may be formed by applying a first electrode active material such as graphite or carbon to a first electrode current collector formed of a metal foil such as copper, a copper alloy, nickel, or a nickel alloy, and may include a first electrode tab 111a (or a first uncoated portion) that is a region to which the first electrode active material is not applied. The first electrode tab 111a may serve as a current flow path between the first electrode plate 111 and the first current collector 120. In some examples, when the first electrode plate 111 is manufactured, the first electrode tab 111a may be formed by being cut in advance so as to protrude to one side, or may be integrally formed with the first electrode plate 111. In some examples, a plurality of first electrode tabs 111a may be collected and tack-welded together, and a separate metal plate (electrode tab) may be welded and coupled to the tack-welded first electrode tabs 111a. In some examples, the first uncoated portion 111a of the first electrode plate 111 may protrude more to one side than the separator 113 without separately cutting of the first electrode plate 111. In one embodiment, a separate metal plate (electrode tab) may be coupled to the first uncoated portion 111a of the first electrode plate 111 exposed to one side of the electrode assembly 110 by welding, or the first current collector 120 may be directly coupled to the first uncoated portion 111a of the electrode assembly 110 by welding.

The second electrode plate 112 may be formed by applying a second electrode active material such as a transition metal oxide on a second electrode current collector formed of a metal foil such as aluminum or an aluminum alloy, and may include a second electrode tab 112a (or a second uncoated portion) that is a region to which the second electrode active material is not applied. The second electrode tab 112a may serve as a current flow path between the second electrode plate 112 and the second current collector 140. In some examples, the second electrode tab 112a may be formed by being cut in advance so as to protrude to the other side when the second electrode plate 112 is manufactured, and may protrude to the other side more than the separator 113 without separately cutting or may be integrally formed with the second electrode plate 112. In some examples, a plurality of second electrode tabs 112a may be collected and tack-welded together, and a separate metal plate (electrode tab) may be welded and coupled to the tack-welded second electrode tabs 112a. In some examples, the second electrode plate 112 may protrude more to one side than the separator 113 without separately cutting of the second electrode plate 112.

In some examples, the first electrode tab 111a may be located on the left short side of the electrode assembly 110, and the second electrode tab 112a may be located on the right short side of the electrode assembly 110. Here, the terms left and right sides are used for convenience of explanation on the basis of the secondary battery 100 shown in FIGS. 1 and 2, and the positions of the secondary battery 100 may vary when the secondary battery 100 rotates left and right or up and down. Hereinafter, various components will be described on the basis of the embodiment of the secondary battery 100 shown in FIGS. 1 to 3.

In some examples, the separator 113 is positioned between the first electrode plate 111 and the second electrode plate 112 to prevent a short circuit and to enable the movement of lithium ions between the first electrode plate 111 and the second electrode plate 112, and may include polyethylene, polypropylene, or a composite film of polyethylene and polypropylene. In addition, the separator 113 may be replaced with an inorganic solid electrolyte such as a sulfide, oxide, or phosphate compound that does not require a liquid or gel electrolyte.

The first current collector 120 and the second current collector 140 electrically connected to the first electrode tab 111a of the first electrode plate 111 and the second electrode tab 112a of the second electrode plate 112, respectively, are positioned at both ends (opposite ends or sides) of the electrode assembly 110. In some examples, the electrode assembly 110 may be accommodated in the case 160 together with an electrolyte.

In some examples, the electrolyte may contain a lithium salt such as LiPF6 or LiBF4 in an organic solvent such as ethylene carbonate (EC), propylene carbonate (PC), diethyl carbonate (DEC), ethyl methyl carbonate (EMC), or dimethyl carbonate (DMC). In addition, the electrolyte may be in a liquid or gel phase. In some examples, when an inorganic solid electrolyte is used, the electrolyte may be omitted.

The first current collector 120 is made of a metal and may electrically connect the first electrode plate 111 and the first terminal 130. The first current collector 120 is a metal plate that can be easily bent, and may have one side in contact with and coupled to the first electrode tab 111a of the electrode assembly 110 by (for example) welding, and another side in contact with and coupled to the first terminal 130 by welding (for example). For instance, in one or more embodiments, the first current collector 120 may be U-shaped.

The first terminal 130 is made of a metal and may be electrically connected to the first current collector 120. In some examples, the first terminal 130 may include a first inner terminal plate 131, a first terminal pillar 132, and a first outer terminal plate 133.

In one or more embodiments, the first inner terminal plate 131 may be positioned inside a first cap plate 171 of the case 160, and the first outer terminal plate 133 may be positioned outside the first cap plate 171. In one or more embodiments, a first coupling member 172 may be between the first outer terminal plate 133 and the first cap plate 171. In addition, a first seal gasket 173 may be between the first terminal pillar 132 and the first cap plate 171 and between the first inner terminal plate 131 and the first cap plate 171. In addition, the first terminal pillar 132 may penetrate the first cap plate 171 to be coupled to the first outer terminal plate 133 from the outside of the first cap plate 171 and to be coupled to the first inner terminal plate 131 from the inside of the first cap plate 171.

The first inner terminal plate 131 may be in contact with and be coupled to one side (the left side in FIG. 2) of the first current collector 120 and the other side (the right side in FIG. 2) of the first current collector 120 is in contact with and coupled to the first electrode tab 111a. The first inner terminal plate 131 may have a terminal hole 131a penetrating between one surface and another surface (opposite surfaces). In one or more embodiments, the terminal hole 131a may be formed to correspond to the diameter of the first terminal pillar 132.

The first terminal pillar 132 may be inserted into the terminal hole 131a of the first inner terminal plate 131 and coupled thereto. For example, the first terminal pillar 132 may be fixed on one surface by riveting or/and welding in a state in which the first terminal pillar 132 is inserted into the terminal hole 131a of the first inner terminal plate 131. The first current collector 120 may be coupled to one surface of the first inner terminal plate 131 that is coupled to the first terminal pillar 132 by, for example, welding.

The first terminal pillar 132 has a pillar shape and may protrude and extend to the outside of the first cap plate 171. In addition, the first terminal pillar 132 may have a flange 132a formed outside the first cap plate 171 so as to prevent the first terminal pillar 132 from coming off from the first cap plate 171. The first terminal pillar 132 may be inserted into and coupled, with respect to the first cap plate 171, to a terminal hole 133a of the first outer terminal plate 133 from the outside and to the first inner terminal plate 131 from the inside. Here, the flange 132a may be positioned between the first outer terminal plate 133 and the first cap plate 171.

The first outer terminal plate 133 may have a terminal hole 133a penetrating between one surface and the other surface (opposite surfaces). An outer extension part of the first terminal pillar 132 may be inserted into and coupled to the terminal hole 133a of the first outer terminal plate 133. For example, the first terminal pillar 132 may be fixed on a surface of the first outer terminal plate 133 located on the left side by riveting or/and welding in a state in which the first terminal pillar 132 is inserted into the terminal hole 133a of the first outer terminal plate 133 from the outside of the first cap plate 171. One surface of the first outer terminal plate 133 is located on the right side and may face the outer surface of the first cap plate 171. In one or more embodiments, a first coupling member 172 made of an insulating material may be between one surface of the first outer terminal plate 133 and an outer surface of the first cap plate 171 for insulation.

The first terminal 130 (e.g., the first inner terminal plate 131, the first terminal pillar 132, and the first outer terminal plate 133) may be made of copper or a copper alloy. In the first terminal 130, the first outer terminal plate 133 and the first terminal pillar 132 may be exposed (at least partially) to protrude outside the first cap plate 171. In addition, inside the first cap plate 171, the first terminal pillar 132 and the first inner terminal plate 131 may be electrically connected to the first current collector 120.

In one or more embodiments, one surface (e.g., a right-facing surface) of the first inner terminal plate 131 may face the left side surface of the electrode assembly 110. In one or more embodiments, the first current collector 120 may be between the one surface (e.g., a right-facing surface) of the first inner terminal plate 131 and the left side surface of the electrode assembly 110, and thus the first terminal 130 and the first electrode tab 111a of the electrode assembly 110 may be electrically connected to each other.

The second current collector 140 is made of a metal and may electrically connect the second electrode plate 112 and the second terminal 150 to each other. The second current collector 140 is a metal plate that can be easily bent and may have one side in contact with and coupled to the second electrode tab 112a of the electrode assembly 110 by (for example) welding, and another side of the second terminal 150 in contact with and coupled by welding (for example). For instance, in one or more embodiments, the second current collector 140 may be U-shaped. In addition, the second current collector 140 may be coupled to the electrode assembly 110 and the second terminal 150 in a form symmetrical to the first current collector 120 relative to (or about) the electrode assembly 110 (e.g., the first current collector 120 and the second current collector 140 may be symmetric). In addition, the second current collector 140 may be made of aluminum or an aluminum alloy.

The second terminal 150 is made of a metal and may be electrically connected to the second current collector 140. In some examples, the second terminal 150 may include a second inner terminal plate 151, a second terminal pillar 152, and a second outer terminal plate 153.

In one or more embodiments, the second inner terminal plate 151 may be positioned inside the second cap plate 181, and the second outer terminal plate 153 may be positioned outside the second cap plate 181, In one or more embodiments, a second coupling member 182 may be between the second outer terminal plate 153 and the second cap plate 181. In addition, a second seal gasket 183 may be between the second terminal pillar 152 and the second cap plate 181 and between the second inner terminal plate 151 and the second cap plate 181. In addition, the second terminal pillar 152 may penetrate the second cap plate 181 to be coupled to the second outer terminal plate 153 from the outside of the second cap plate 181 and to be coupled to the second inner terminal plate 151 from the inside of the second cap plate 181.

In one or more embodiments, the second terminal 150 may be the same as the first terminal 130 in terms of shape and structure. The second terminal 150 may be coupled to the electrode assembly 110 through the second current collector 140 in a form symmetrical to the first terminal 130 with respect to (about) the electrode assembly 110. In addition, the second terminal 150 may be made of aluminum or an aluminum alloy.

The case 160 is shaped of a substantially hollow rectangular parallelepiped having openings 161 and 162 formed on both sides (opposite sides), and the electrode assembly 110 coupled to the first current collector 120 and the second current collector 140 may be inserted into the case 160 through one of the openings 161 and 162.

The case 160 may include a first rectangular side surface extending along the longitudinal direction of the case, a second rectangular side surface opposite to the first rectangular side surface, and two rectangular upper and lower surfaces connecting the long sides of the first and second rectangular side surfaces and extending along the longitudinal direction. The case 160 may have one upper surface, one lower surface, and two long side surfaces integrally formed. In addition, the length of the case 160 in the longitudinal direction may be longer than the length of the case 160 in the height direction (the longitudinal direction of the first cap assembly 170 and the second cap assembly 180) that vertically connects the upper surface and the lower surface. Hereinafter, the height direction means the height direction of the case 160. In addition, the length of the case 160 in the longitudinal direction may be twice or more than the length in the height direction.

The case 160 may have a plurality of vent holes penetrating the upper surface. Safety vents 163 and 164 may be installed in two of the vent holes. A first safety vent 163 and a second safety vent 164 installed in the case 160 may be spaced apart from each other along the longitudinal direction of the case 160. The first safety vent 163 and the second safety vent 164 may be shaped of a thinner plate than other regions of the case 160. The first safety vent 163 and the second safety vent 164 may have long circular shapes (e.g., an oval, an ellipse, or an oblong shape) extending along the longitudinal direction. That is, in one or more embodiments, the first safety vent 163 and the second safety vent 164 may have two long sides parallel to each other, and may have two semicircular short sides connecting ends of the two long sides.

The width of the case 160 in the area provided with the first safety vent 163 and/or the second safety vent 164 may be smaller than the width of the first safety vent 163 or the second safety vent 164 in the longitudinal direction of the case 160. In one embodiment, the width of the case 160 may be a length in a direction perpendicular to the longitudinal direction. The widths of the first safety vent 163 and the second safety vent 164 may correspond to the lengths in which the two parallel long sides of the case 160 are connected to the upper and lower surfaces of the case 160. That is, the width of the first safety vent 163 and/or the width of the second safety vent 164 may be greater than the width of the case 160 in the region where the first safety vent 163 and/or the second safety vent 164 is provided (e.g., the width of each of the first safety vent 163 and the second safety vent 164 along the longitudinal direction of the case 160 may be longer than the width of the case 160 in a direction perpendicular to the longitudinal direction and the height direction of the case 160).

In addition, the first safety vent 163 and the second safety vent 164 may have notches 163a and 164a, respectively, formed to open at a set pressure. As an example, in the first safety vent 163 and the second safety vent 164, when the internal pressure of the secondary battery 100 increases due to an event such as overcharging or penetration, the notches 163a and 164a are ruptured to prevent internal gas and internal heat from being discharged.

The notches 163a and 164a may be thinner than other areas of the safety vents 163 and 164. The notches 163a and 164a may include a central slit extending along the longitudinal direction of the case 160 and two additional slits having a predetermined angle with the central slit and extending outward from both ends of the central slit (e.g., a central slit and arrow shaped slits at opposite ends of the central slit that point inward toward each other). That is, the additional slits may include two additional slits extending obliquely from one end of the central slit and two additional slits extending obliquely from the other end (opposite end) of the central slit.

The shapes of the notches 163a and 164a may be changed in various manners. However, the first safety vent 163 and the second safety vent 164 may have the same shape and structure, and the shape and thickness of the notches 163a and 164a may also be the same. That is, the notches 163a and 164a of the first safety vent 163 and the second safety vent 164 may be ruptured in the same or similar pressure range.

The case 160 may have a longitudinal length 160W (see FIG. 3) of 300 mm or more. When the length 160W of the case 160 in the longitudinal direction is 300 mm or more, two safety vents 163 and 164 may be provided along the length direction to facilitate discharge of internal gas and heat from the case 160. In addition, the surface(s) of the case 160 on which the safety vents 163 and 164 are located may be the lower surface of the secondary battery 100 and the case 160.

Referring to FIG. 4 and Table 1, the experimental results for the pressure inside the case 160 for the entire area (cumulative area) of the safety vents 163 and 164 of the secondary battery 100 of the present disclosure shown in FIGS. 1 to 3 are shown. In addition, FIG. 4 and Table 1 show experimental results for the pressure inside the case 160 with respect to the entire area of the safety vent when only one safety vent is provided in the case and when the case is provided with three safety vents as comparative examples. The secondary battery of the comparative examples may have the same configuration as the secondary battery 100 of the present disclosure, except for the number of safety vents. In addition, according to the experimental results of FIG. 4 and Table 1, the length 160W of the case 160 in the longitudinal direction may be 300 mm. In addition, the experimental results may be results on the internal pressure of the case when the entire areas of the safety vent are 300 mm², 400 mm², 600 mm², and 900 mm². In one embodiment, when a safety vent of a secondary battery is opened, the gas and heat may be discharged so that the internal pressure of the case 160 reaches a target pressure (e.g., approximately 10 Kgf/cm²). In addition, the pressure inside a case may be a result obtained by measuring a pressure immediately after an event occurs in the secondary battery and the safety vent is opened.

TABLE 1

| Safety vent | | | Internal pressure of |
|---|---|---|---|
| | Area by vent | Entire (cumulative) vent | case |
| Number | (mm²) | area (mm²) | (Kgf/cm²) |
| 1 | 300 | 300 | 26.7 |
| | 400 | 400 | 23.9 |
| | 600 | 600 | 22.2 |
| | 900 | 900 | 21.7 |
| 2 | 150 | 300 | 23.4 |
| | 200 | 400 | 20.0 |
| | 300 | 600 | 17.5 |
| | 450 | 900 | 16.7 |
| 3 | 100 | 300 | 23.7 |
| | 133 | 400 | 20.2 |
| | 200 | 600 | 17.7 |
| | 300 | 900 | 16.9 |

As shown in FIG. 4 and Table 1, even if the entire (cumulative) vent area is the same, the pressures inside the case may be different depending on the number of safety vents. That is, even if the entire (cumulative) vent area is the same, it can be seen that the internal pressure of the case 160 is closer to the target pressure when the case 160 has two vents compared to only a single vent because gas and heat are more easily discharged when the case 160 has two safety vents than when the case 160 has only one safety vent. In addition, if the entire (cumulative) area of the safety vents is the same, it can be seen that the pressures inside the case due to discharge of gas and heat inside the case are similar when two safety vents are provided and when three safety vents are provided. Even if the case 160 has a length 160W of 300 mm or more in the longitudinal direction, the same effect may be obtained when two safety vents are provided and when three safety vents are provided, and thus providing three or more safety vents may only increase the number of unnecessary safety vents. Indeed, as shown in Table 1, the pressures inside the case are slightly lower when the case has two safety vents compared to three vents for the same entire (cumulative) area of the vents.

The first cap assembly 170 may be coupled to the left opening 161 of the case 160. In some examples, the first cap assembly 170 may include a first cap plate 171, a first coupling member 172, and a first seal gasket 173. The first cap plate 171 is shaped of a flat rectangular plate and may seal the left opening 161 of the case 160. The first cap plate 171 may have a terminal hole 171a penetrating between an outer surface and an inner surface thereof. The first terminal pillar 132 may penetrate the terminal hole 171a of the first cap plate 171 to be coupled to the first cap plate 171. In addition, the first terminal pillar 132 may be coupled to the first outer terminal plate 133 on the left side of the first cap plate 171, and may be coupled to the first inner terminal plate 131 on the right side of the first cap plate 171. In one or more embodiments, the first inner terminal plate 131 and a portion of the right side (inner side) of the first terminal pillar 132 may be located inside the case 160.

The first coupling member 172 may be between the outer surface of the first cap plate 171 and the first outer terminal plate 133. The first coupling member 172 may come into close contact with the first cap plate 171 and also come into close contact with the first seal gasket 173. The first coupling member 172 may be made of an insulating material and may insulate the first cap plate 171 and the first outer terminal plate 133 from each other and may insulate the first cap plate 171 and the first terminal pillar 132 from each other.

In addition, the first seal gasket 173 is made of an insulating material and is between the first cap plate 171 and the first terminal 130 to seal a space between the first cap plate 171 and the first terminal 130. That is, the first seal gasket 173 may be between the first cap plate 171 and the first terminal post 132 and between the first cap plate 171 and the first inner terminal plate 131. The first seal gasket 173 may prevent (or at least mitigate against) external moisture from penetrating into the secondary battery 100 or may prevent (or at least mitigate against) an electrolyte contained in the secondary battery 100 from leaking to the outside.

In addition, after the electrode assembly 110 to which the first current collector 120 is coupled is accommodated in the case 160, the first cap plate 171 coupled to the first terminal 130 seals the opening of the case 160. Before the first cap plate 171 seals the case 160, a first terminal coupling portion 120c of the first current collector 120 and the first inner terminal plate of the first terminal 130 may be coupled to each other by welding. In addition, after the first collector 120 and the first terminal 130 are coupled to each other, a connection part 120a of the first collector 120 may be easily bent, and thus the first cap plate 171 is easily coupled to the opening 161 of the case 160.

The second cap assembly 180 may be coupled to the right opening 162 of the case 160. In some examples, the second cap assembly 180 may include a second cap plate 181, a second coupling member 182, and a second seal gasket 183. The second cap assembly 180 may be the same as the first cap assembly 170 in terms of shape and structure. In addition, the coupling shape and structure of the second cap assembly 180 and the second terminal 150 may be the same as those of the first cap assembly 170 and the first terminal 130, respectively. The coupling shape of the second cap assembly 180 and the second terminal 150 may be symmetrical to the coupling shape of the first cap assembly 170 and the first terminal 130, with respect to the case 160 (e.g., the second cap assembly 180 and the second terminal 150 may be symmetric to the first cap assembly 170 and the first terminal 130, respectively, with respect to (about) the case 160).

In the secondary battery 100, the first cap assembly 170 coupled to the first terminal 130 is coupled to the left side opening 161 of the case 160, and the second cap assembly 180 coupled to the second terminal 150 is coupled to the right side opening 162 of the case 160, and thus the first terminal 130 and the second terminal 150 are located on both sides (opposite sides) of the case 160. The secondary battery 100 includes the first terminal 130 and the second terminal 150 on both sides (opposite sides) and thus, when a plurality of secondary batteries 100 are combined in a module form (e.g., stacked on top of each other), a cooling member (not shown) may be coupled to upper and lower regions (e.g., the upper rectangular surface and/or the lower rectangular surface) of the case 160, respectively, thereby suppressing deterioration of the secondary battery 100 and improving cooling performance.

As an example, in a state in which the long side surfaces of the plurality of secondary batteries 100 face each other, the battery module may electrically connect first terminals and/or second terminals respectively exposed to both sides (opposite sides) of the case 160.

In addition, the secondary battery 100 includes a first terminal 130 and a second terminal 150 on both sides (opposite sides) and thus, when a plurality of secondary batteries 100 are combined in a module form, a charge/discharge current flows through each terminal in both directions, thereby suppressing deterioration, compared to a case where two terminals are provided on one side and charge/discharge current flows along two terminals on one side only. In addition, when a plurality of secondary batteries 100 are combined in a module form, since each terminal can be connected in both directions, space utilization can be increased.

In addition, since the secondary battery 100 has two safety vents 163, 164 spaced apart from each other in the longitudinal direction of the case 160, internal gas and heat are easily discharged, and heat propagation to adjacent secondary batteries can be prevented.

As described above, since the secondary battery of the present disclosure has two vents spaced apart from each other in the longitudinal direction of the case, internal gas and heat are easily discharged, and thus heat propagation to adjacent secondary batteries can be prevented from occurring when an event occurs.

In addition, the secondary battery of the present disclosure includes a first terminal and a second terminal, respectively, provided on both sides, and thus, even when a plurality of secondary batteries are combined in a module form, cooling members can be coupled to upper and lower regions of a case, respectively, thereby suppressing deterioration of the secondary battery, and improving cooling performance.

In addition, the secondary battery of the present disclosure includes a first terminal and a second terminal, respectively, provided on both sides, and thus, when a plurality of secondary batteries are combined in a module form, charge/discharge current flows along each terminal from both directions, and thus deterioration due to charge/discharge current can be suppressed and space utilization can be increased.

While the foregoing embodiment has been described to practice the secondary battery according to the present disclosure, it should be understood that the embodiment described herein should be considered in a descriptive sense only and not for purposes of limitation, and various changes in form and details may be made therein without departing from the spirit and scope of the disclosure as defined by the following claims.

What is claimed is:

1. A secondary battery comprising:
an electrode assembly having a first electrode tab exposed at a first side and a second electrode tab exposed at a second side;
a case accommodating the electrode assembly and having a first side opening corresponding to the first side of the electrode assembly, and a second side opening corresponding to the second side of the electrode assembly;
a first cap plate sealing the first side opening of the case;
a first terminal electrically connected to the first electrode tab and exposed to an outside of the first cap plate;
a second cap plate sealing the second side opening of the case; and
a second terminal electrically connected to the second electrode tab and exposed to an outside of the second cap plate,
wherein the case comprises a plurality of safety vents on one surface of the case.

2. The secondary battery of claim 1, wherein the case comprises:
a rectangular lower surface extending in a longitudinal direction;
a rectangular upper surface extending along the longitudinal direction and facing the rectangular lower surface; and
two long side surfaces connecting long sides of the rectangular upper surface and the rectangular lower surface.

3. The secondary battery of claim 2, wherein the case has a rectangular parallelepiped shape, and wherein the rectangular lower surface, the rectangular upper surface, and the two long side surfaces are integral.

4. The secondary battery of claim 1, wherein the plurality of safety vents comprises only a first safety vent and a second safety vent spaced apart from each other along a longitudinal direction of the case.

5. The secondary battery of claim 4, wherein each of the first safety vent and the second safety vent comprises a notch having a smaller thickness than other regions of the first safety vent and the second safety vent.

6. The secondary battery of claim 5, wherein a shape and a thickness of the notch of the first safety vent are same as those of the notch of the second safety vent.

7. The secondary battery of claim 4, wherein the notch includes a central slit extending in the longitudinal direction and additional slits extending outward at a predetermined angle from both ends of the central slit.

8. The secondary battery of claim 7, wherein the additional slits include two additional slits extending obliquely from one end of the central slit and two additional slits extending obliquely from another end of the central slit.

9. The secondary battery of claim 4, wherein the first safety vent and the second safety vent have an elongated circular shape extending in the longitudinal direction.

10. The secondary battery of claim 4, wherein the first safety vent and the second safety vent have widths greater than a width of the case in a region including the first safety vent and the second safety vent.

11. The secondary battery of claim 1, wherein the first terminal comprises:
a first inner terminal plate inside the first cap plate;
a first outer terminal plate outside the first cap plate; and
a first terminal pillar coupled to the first inner terminal plate from the inside of the first cap plate and penetrating the first cap plate and coupled to the first outer terminal plate from the outside of the first cap plate.

12. The secondary battery of claim 1, further comprising:
a second cap plate sealing the second side opening of the case; and
a second terminal electrically connected to the second electrode tab and exposed to the outside of the second cap plate.

13. The secondary battery of claim 2, further comprising:
a first current collector electrically connecting the first electrode tab and the first terminal; and
a second current collector electrically connecting the second electrode tab and the second terminal.

14. The secondary battery of claim 1, wherein a length of the case in the longitudinal direction is twice or more than a length of the case in a height direction.

15. The secondary battery of claim 1, wherein the case has a longitudinal length of 300 mm or more.

16. The secondary battery of claim 1, wherein the plurality of safety vents is formed on a lower surface of the case.
